(19) United States
(12) Patent Application Publication
(10) Pub. No.: US 2026/0295534 A1
(43) Pub. Date: Oct. 1, 2026

(54) SYSTEMS AND METHODS FOR LITHIUM EXTRACTION FROM AQUEOUS FEEDSTOCKS

(71) Applicant: UNIVERSITY OF UTAH RESEARCH FOUNDATION, Salt Lake City, UT (US)

(72) Inventors: Tao GAO, Salt Lake City, UT (US); Yunan QIN, Salt Lake City, UT (US)

(21) Appl. No.: 19/476,981

(22) PCT Filed: May 17, 2024
(86) PCT No.: PCT/US2024/029923

§ 371 Date: Oct. 20, 2025

Related U.S. Application Data
(60) Provisional application No. 63/503,409, filed on May 19, 2023.

(51) Int. Cl. B01D 61/42; C01D 15/02; C01D 15/08; C25C 1/02

(52) U.S. Cl. CPC B01D 61/422; C01D 15/02; C01D 15/08; C25C 1/02

(57) ABSTRACT

Described herein are systems and methods for electrochemical absorption/desorption for continuous and selective lithium extraction from aqueous lithium feedstocks. The disclosed systems and methods comprise symmetric electrodes having lithium selective material which absorbs and desorbs lithium ions based on an electric field voltage bias. By continuously cycling the voltage bias between positive and negative electric potentials, the absorption and desorption of lithium ions can be selectively controlled to allow efficient lithium extraction.

### CROSS-REFERENCE TO RELATED APPLICATIONS

This application claims priority to U.S. Provisional Patent Application No. 63/503,409, filed on May 19, 2023, which is incorporated by reference herein in its entirety.

### TECHNICAL FIELD

This disclosure generally relates to systems and methods for electrochemical lithium extraction from aqueous lithium feedstocks.

### BACKGROUND

Lithium (Li) is an important element used in a wide variety of applications including making rechargeable batteries, and in the production of ceramics and glass, casting, and lubricants. The global Li market is expected to grow at a compound annual growth rate of 12.8% from 2024 to 2030. As the demand for lithium continues to rise, efforts to extract lithium from geological and brine sources also continue to expand. The prevailing industrial method for extracting lithium from brine is solar evaporation followed by precipitation. However, this process is slow, hard to scale up, water-intensive, chemical-intensive, waste-intensive, energy inefficient, and has a huge land footprint.

Electrochemical methods have been developed that eliminate the multi-step chemical precipitation prior to lithium production, leading to reduction in chemical usage and waste production as compared to solar evaporation processes. However, these electrochemical processes still require pre-evaporation and post-evaporation steps to increase lithium concentration, which leads to significant water loss. In addition, the post-evaporation step of these electrochemical processes uses thermal energy (i.e., heat) to achieve fast separation, which has a very high energy consumption and carbon emission.

What is needed are new and improved systems and methods for selectively and efficiently extracting lithium from various feedstocks with low-to-zero water usage, low chemical consumption and waste production, and low environmental footprint. Such systems and methods would be useful in a variety of research, environmental, and commercial applications.

### SUMMARY

One embodiment described herein is a system for continuously and selectively extracting lithium from an aqueous lithium feedstock, the system comprising: an electrochemical cell comprising: a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet; a source of the aqueous lithium feedstock selectively fluidly coupled to either the first subchannel inlet or the second subchannel inlet through a first valve, the first valve being adapted to selectively adjust a fluid flow of the aqueous lithium feedstock from the source of the aqueous lithium feedstock to either the first subchannel inlet or the second subchannel inlet; a source of an extraction solution selectively fluidly coupled to either the first subchannel inlet or the second subchannel inlet through a second valve, the second valve being adapted to selectively adjust a fluid flow of the extraction solution from the source of the extraction solution to either the first subchannel inlet or the second subchannel inlet; a valve controller adapted to selectively configure the first and second valves such that when the source of the aqueous lithium feedstock is fluidly coupled to the first subchannel inlet, the source of the extraction solution is fluidly coupled to the second subchannel inlet, and when the source of the aqueous lithium feedstock is fluidly coupled to the second subchannel inlet, the source of the extraction solution is fluidly coupled to the first subchannel inlet; a fluid flow source operably coupled to the source of the aqueous lithium feedstock and the source of the extraction solution, the fluid flow source being configured to induce fluid flow of the aqueous lithium feedstock from the source of the aqueous lithium feedstock through either the first subchannel or the second subchannel and induce fluid flow of the extraction solution from the source of the extraction solution through either the first subchannel or the second subchannel; an electric potential source electrically coupled to the first and second electrodes; and an electric potential controller adapted to selectively adjust the electric potential applied to the first and second electrodes such that when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode. In one aspect, the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof. In another aspect, the aqueous lithium feedstock comprises additional ions of sodium, potassium, magnesium, manganese, calcium, chloride, bromide, sulfate, or combinations thereof. In another aspect, the extraction solution comprises an aqueous salt solution comprising potassium chloride, sodium chloride, or a combination thereof. In another aspect, the lithium selective material comprises lithium iron phosphate, lithium manganese oxide, lithium titanium oxide, or combinations thereof. In another aspect, each of the first and second electrodes comprises a size ranging from about 4 cm² to about 10 m². In another aspect, the electric potential applied to the first and second electrodes ranges from about 100 mV to about 1500 mV. In another aspect, the fluid flow source is a pump. In another aspect, the system comprises a plurality of electrochemical cells. In another aspect, the plurality of electrochemical cells comprises up to about 500 electrochemical cells stacked in parallel. In another aspect, the system extracts lithium in the form of an aqueous lithium chloride solution. In another aspect, the system further comprises an electrodialysis flow cell. In another aspect, the electrodialysis flow cell is configured to convert aqueous lithium chloride solution into aqueous lithium hydroxide solution. In another aspect, the system further comprises a source of carbon dioxide gas to precipitate the aqueous lithium hydroxide solution to generate solid lithium carbonate. In another aspect, the system is operated at room temperature. In another aspect, the system is carbon negative. In another aspect, the system has a selectivity for lithium of at least about 85% over other ions.

Another embodiment described herein is a method of continuously and selectively extracting lithium from an aqueous lithium feedstock, the method comprising: (a) providing an electrochemical cell comprising: a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet; (b) inducing a fluid flow of the aqueous lithium feedstock from a source of the aqueous lithium feedstock to either the first subchannel inlet or the second subchannel inlet, and simultaneously inducing a fluid flow of an extraction solution from a source of the extraction solution to either the first subchannel inlet or the second subchannel inlet, wherein the aqueous lithium feedstock and the extraction solution simultaneously flow to opposing first or second subchannel inlets; (c) applying an electric potential to the first and second electrodes such that the first electrode and the second electrode have opposing positive or negative electric potentials, wherein when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode; (d) switching the fluid flow of the aqueous lithium feedstock to the opposing first or second subchannel inlet, and simultaneously switching the fluid flow of the extraction solution to the opposing first or second subchannel inlet; and (e) switching the electric potential of the first and second electrodes to the opposing positive or negative electric potential. In one aspect, the method further comprises: (f) repeating steps (b)-(e) one or more times. In another aspect, the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof. In another aspect, the aqueous lithium feedstock comprises additional ions of sodium, potassium, magnesium, manganese, calcium, chloride, bromide, sulfate, or combinations thereof. In another aspect, the extraction solution comprises an aqueous salt solution comprising potassium chloride, sodium chloride, or a combination thereof. In another aspect, the lithium selective material comprises lithium iron phosphate, lithium manganese oxide, lithium titanium oxide, or combinations thereof. In another aspect, the electric potential applied to the first and second electrodes ranges from about 100 mV to about 1500 mV. In another aspect, the fluid flow of the aqueous lithium feedstock and the extraction solution is induced using a pump. In another aspect, the method extracts lithium in the form of an aqueous lithium chloride solution. In another aspect, the method further comprises adding the extracted lithium to an electrodialysis flow cell. In another aspect, the electrodialysis flow cell converts aqueous lithium chloride solution into aqueous lithium hydroxide solution. In another aspect, the method further comprises adding carbon dioxide gas to precipitate the aqueous lithium hydroxide solution and generate solid lithium carbonate. In another aspect, the method is performed at room temperature. In another aspect, the method is carbon negative. In another aspect, the method has a selectivity for lithium of at least about 85% over other ions.

This disclosure provides for other aspects and embodiments that will be apparent in light of the following detailed description and accompanying figures.

### DESCRIPTION OF THE DRAWINGS

FIG. 1 shows a schematic illustration of a basic electrochemical lithium extraction process using an electric field potential and a flow cell with electrodes having lithium selective material to generate substantially pure or completely pure lithium ion (Li⁺) solution from an aqueous brine feedstock containing a plurality of ions. The extracted Li⁺ solution can then be further treated through other concentration and precipitation processes to form a solid lithium salt extract product.

FIG. 2A shows a schematic illustration of an exemplary lithium extraction absorption/desorption process, termed direct lithium extraction (DLE), that includes an electrochemical cell containing an anion exchange membrane separating two symmetric electrodes having the same lithium (Li⁺) selective material. Carrier and feedstock streams flow through separate flow subchannels of the electrochemical cell and lithium is desorbed from and absorbed into the lithium selective material of the electrodes using an electric potential to generate an electric field across the cell.

FIG. 2B shows a schematic illustration of an exemplary electrochemical DLE process using continuous cycling between a positive voltage bias and a negative voltage bias to extract lithium from a lithium feed stream using the electrochemical cell of FIG. 2A and a carrier stream of extraction solution. When the lithium selective material (i.e., absorbent) becomes saturated with lithium ion at one electrode, the electric potential voltage polarity is switched between the two symmetric electrodes, and the flow of the feed and carrier streams are switched between the two adjacent flow subchannels separated by the anion exchange membrane within the flow channel of the electrochemical cell. This results in a continuous absorption of the lithium ion from the feed stream into the lithium selective material of the electrodes and desorption of the lithium ion from the lithium selective material of the electrodes into the carrier stream, thereby maximizing lithium extraction. The lithium-rich extract can be collected in a separate reservoir for analysis, subjected to further treatment, or otherwise removed from the extraction system, or the lithium-rich extract can be recycled and reintroduced into the carrier stream source of extraction solution. The lithium-depleted raffinate can be discarded or otherwise removed from the extraction system, or the lithium-depleted raffinate can be recycled and reintroduced into the feed stream source.

FIG. 3 shows a schematic illustration of an exemplary electrochemical DLE process that continuously switches the electric potential (current/voltage) between electrodes and the fluid flow of feed and carrier streams between flow subchannels. AEM—anion exchange membrane. In this non-limiting example, the feed stream contains a plurality of ions in addition to lithium. The process results in a continuous cycling between Steps 1 and 2 of absorption of the lithium ion from the feed stream into the lithium selective material of a lithium-poor electrode and desorption of the lithium ion from the lithium selective material of a lithium-rich electrode into the carrier stream. This design allows simultaneous Li absorption and desorption in one step, which enables two absorption steps in one electrochemical cycle. The constant voltage operation allows precise control of the absorption driving force, which enables the accurate match of the absorption rate with mass transfer rate, thereby eliminating mass transfer limitation, avoiding side reactions, and maximizing lithium selectivity and durability. In this non-limiting example, the lithium-depleted raffinates from each flow subchannel are recycled and reintroduced into the feed stream source, and the lithium-rich extracts from each flow subchannel are recycled and reintroduced into the carrier stream source. The lithium ion concentrations in the two electrodes during absorption/desorption are depicted on the bottom of the figure.

FIG. 4 shows an exemplary process flowchart for lithium extraction from various types of feedstocks to generate solid Li₂CO₃ extract product. Example feedstocks can include salt lake brines (e.g., Great Salt Lake (GSL) brine) having a lithium concentration of about 20 ppm, industry brines having a lithium concentration of hundreds ppm, and leaching solutions having a lithium concentration of hundreds ppm. Optional pre-treatment steps for these feedstocks can include brine filtration to remove particulate matter and preparation of the leaching solution for subsequent direct Li extraction (DLE) processes. The DLE step extracts Li from the feed while rejecting other ions (e.g., Mg, Ca, K, Na, etc.), producing a substantially pure or completely pure LiCl solution and a Li-depleted raffinate stream containing the other rejected ions. In this non-limiting illustrative example process, the Li-depleted raffinate streams from the DLE separation unit are recycled and discharged back into the feed source. However, in other configurations depending on the particular application and feed source, the raffinate streams can also be discarded or otherwise removed from the system. Downstream electrodialysis can then convert the generated LiCl solution from DLE to a concentrated LiOH solution. Additional post-treatment steps produce Li₂CO₃ solids as a final product by chemical precipitation using CO₂ as the carbon source.

FIG. 5 shows a schematic illustration for an exemplary scalable configuration of multiple electrochemical cells stacked in parallel. In this example, one stack is one electrochemical cell. Bipolar plates can be used to help conduct electrical current from one cell stack to the next.

FIG. 6A shows a photograph of a benchtop prototype for an exemplary continuous electrochemical DLE system including a pump for inducing fluid flow, an electrochemical cell reactor for lithium ion absorption/desorption, an electric potential source, a lithium feedstock source (labeled “feed”), and a carrier stream source of extraction solution (labeled “extract”). In this non-limiting example, the lithium-depleted raffinates from each flow subchannel are recycled and reintroduced into the lithium feedstock source, and the lithium extract solutions from each flow subchannel are recycled and reintroduced into the carrier stream source.

FIG. 6B shows a zoomed-in photograph of the electrochemical cell reactor of FIG. 6A. As depicted, in one single step, the aqueous lithium feedstock (feed) flows through the top flow subchannel while the extraction solution (carrier) simultaneously flows through the bottom flow subchannel, with the two flow subchannels being separated by an anion exchange membrane to block the transport of cations and allow the transport of anions (e.g., Cl⁻). A positive electric potential is applied to the bottom electrode that is in fluid communication with the carrier, while a negative electric potential is applied to the top electrode that is in fluid communication with the feed. This results in desorption of lithium ion from the lithium selective material of the bottom electrode into the carrier, and absorption of lithium ion from the feed into the lithium selective material of the top electrode. Lithium-depleted raffinate solution exits the top flow subchannel and lithium-rich extract solution exits the bottom flow subchannel. This continuous cycle between the flow subchannels and electrodes can be repeated as many times as necessary to maximize lithium extraction.

FIG. 7 shows a graph of the required voltage to drive the absorption of different cations into the symmetric electrodes of the exemplary DLE system shown in FIG. 6A. The current is shown on a log scale.

Before any embodiments of this disclosure are explained in detail, it is to be understood that the disclosure is not limited in its application to the details of construction and the arrangement of components set forth in the following description or illustrated in the accompanying figures. Also, it is to be understood that the phraseology and terminology used herein is for the purpose of description and should not be regarded as limiting.

### DETAILED DESCRIPTION

Described herein are various electrochemical systems and methods for continuously and selectively extracting lithium from an aqueous lithium feedstock. The systems and methods described herein use a continuous direct lithium extraction (DLE) approach that comprises the use of one or more electrochemical cells capable of lithium absorption from an aqueous lithium feedstock and desorption to an extraction solution using continuous cycles of positive and negative voltage bias. The electrochemical cells described herein comprise symmetric first and second electrodes having the same lithium selective material and spaced apart such that a flow channel is created in the electrochemical cell. An anion exchange membrane separates the flow channel into flow subchannels where the aqueous lithium feedstock and the extraction solution flow through separately and simultaneously for lithium absorption into and lithium desorption from the lithium selective material of the electrodes, respectively.

In some embodiments, the aqueous lithium feedstock may be subjected to one or more pre-treatment processes prior to the described DLE absorption/desorption systems and methods. In some embodiments, the extracted lithium from the described DLE absorption/desorption systems and methods may be subjected to one or more further treatment or refinement processes (e.g., electrodialysis; precipitation).

The systems and methods described herein provide a more environmentally friendly and energy-efficient approach to lithium extraction as compared to conventional systems and methods by having the ability to achieve zero water usage, reduced chemical/waste/energy levels, and negative carbon emissions. The systems and methods described herein can also be easily scaled up to industry levels and integrated into existing industry systems and processes that generate lithium-containing feedstocks (e.g., brines).

### Definitions

Unless otherwise defined herein, all technical and scientific terms used in connection with the present disclosure have the same meaning as commonly understood by one of ordinary skill in the art. The meaning and scope of the terms should be clear. In case of conflict, the present document, including definitions, will control. Preferred methods and materials are described below, although methods and materials similar or equivalent to those described herein can be used in practice or testing of the present disclosure. Further, unless otherwise required by context, singular terms shall include pluralities and plural terms shall include the singular. All publications, patent applications, patents and other references mentioned herein are incorporated by reference in their entirety. The materials, methods, and examples disclosed herein are illustrative only and not intended to be limiting.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “,” “an,” or “the” means “one or more” unless otherwise specified. Thus, for example, reference to “a membrane” includes reference to one or more of such membrane materials and reference to “an electrode” refers to one or more of such electrodes.

As used herein, the term “or” can be conjunctive or disjunctive.

As used herein, the term “and/or” refers to both the conjunctive and disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “~” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points.

As used herein, the terms “control,” or “reference” are used herein interchangeably. A “reference” or “control” level may be a predetermined value or range, which is employed as a baseline or benchmark against which to assess a measured result. “Control” also refers to control experiments or control conditions.

As used herein, the term “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein.

As used herein, the terms “aqueous lithium feedstock,” “feed,” “feedstock,” “feed stream,” and “feedstock solution” are used interchangeably. The feedstock can be any natural or industry-generated lithium ion-containing aqueous solution or brine (e.g., brine, lake water, sea water, industrial effluent, etc.). The feedstock solution can also be a leaching solution produced by mixing an acid with a lithium-containing ore. The feedstock can include lithium ions and a plurality of other ions (e.g., sodium, potassium, magnesium, calcium, chloride, bromide, sulfate, etc.). In some embodiments, the feedstock may comprise a brine, a lake brine, lake water, sea water, industrial effluent, industry brine, salt lake water, a geothermal brine, a desalinization plant brine, an oilfield brine, a leaching solution. In some embodiments, the feedstock may comprise additional ions of sodium, potassium, magnesium, manganese, calcium, chloride, bromide, sulfate, or combinations thereof.

As used herein, the terms “extraction solution,” “extract solution,” “carrier,” “carrier fluid,” and “carrier stream,” are used interchangeably. The extraction solution can be any aqueous solution containing a salt to provide background conductivity for the lithium extraction systems and methods described herein. In some embodiments, the extraction solution comprises an aqueous salt solution comprising potassium chloride, sodium chloride, or a combination thereof.

As used herein, the terms “lithium selective material,” “lithium ion selective material,” “Li selective material,” “lithium insertion material,” “lithium intercalation material,” “Li intercalation material,” and “absorbent” are used interchangeably. Li intercalation materials are a type of electro-active crystalline material with interstitial sites in the lattice that can be occupied by lithium ion. They are designed as cathode materials for Li-ion batteries and therefore have high absorption capacity and selectivity toward lithium. In addition, the absorption of lithium ion does not change the crystalline structure of the material, allowing these materials to be very durable absorbents. Because the absorbents are electro-active, the speed of lithium absorption and desorption can be easily adjusted by controlling the applied electric potential, which enables much faster separation than chemical adsorption processes. Suitable lithium selective materials for the systems and methods described herein include, but are not limited to, lithium nickel manganese cobalt oxide (NMC) (LiNiMnCoO₂), lithium-rich NMC, lithium nickel manganese oxide (LiNi_{0.5}Mn_{1.5}O₄), lithium-rich layered oxides, lithium cobalt oxide (LiCoO₂), lithium iron phosphate (LiFePO₄), lithium manganese oxide (LiMn₂O₄), lithium titanium oxide (Li₄Ti₅O₁₂), lithium nickel cobalt aluminum oxide (NCA) (LiNiCoAlO₂), and combinations thereof. In some non-limiting embodiments, the lithium selective material comprises lithium iron phosphate, lithium manganese oxide, lithium titanium oxide, or combinations thereof.

As used herein, the term “selectivity,” in reference to, for example, lithium extraction yield, can be defined as the ratio of the Li⁺ ion concentration in an extraction solution to the total cation concentration in the extraction solution. In some embodiments described herein, the lithium extraction systems and methods may have a selectivity for lithium of at least about 85% over other ions. In some embodiments, the selectivity for lithium over other ions may be even greater than 90%.

### Continuous Direct Lithium Extraction (DLE)

Described herein are continuous electrochemical direct lithium extraction (DLE) systems and methods. The systems and methods involve continuous lithium absorption/desorption for lithium extraction from aqueous lithium feedstock, and include symmetric electrodes with lithium selective material which absorbs and desorbs lithium ions based on a voltage bias of an electric field. By continuously cycling voltage bias from positive to negative, the absorption and desorption of lithium ions can be selectively controlled to allow lithium ions to be removed and extracted more efficiently.

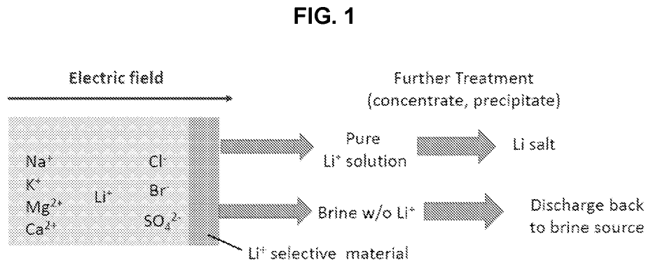

FIG. 1 is a schematic illustration of a basic exemplary electrochemical lithium extraction process using an electric field potential and electrodes with lithium selective material to generate a substantially pure or completely pure lithium ion (Li⁺) solution from an aqueous brine feedstock containing a plurality of ions. The Li⁺ solution can then be further treated through other concentration and precipitation processes to form a solid lithium salt product.

As a general guideline, a solution feedstock can include lithium ions and a plurality of other ions (i.e., sodium, potassium, magnesium, calcium, chloride, bromide, sulfate, etc.). The solution feedstock can be any lithium ion-containing brine or solution (e.g., brine, lake water, sea water, industrial effluent, etc.). In some cases, the solution feedstock can be a leaching solution produced by mixing an acid with a lithium-containing ore. A lithium ion selective material can be chosen which is responsive to an applied electric field to selectively absorb and desorb lithium ions (i.e., without appreciable amounts of other non-lithium ions). Non-limiting examples of lithium ion selective materials can include lithium iron phosphate, lithium manganese oxide, lithium titanium oxide, lithium battery cathode materials, and the like. As a general guideline, the absorbent can be chosen to selectively extract lithium ion (Li⁺) from the aqueous solution while leaving all other cations (Na⁺, Mg²⁺, Ca²⁺, K⁺, etc.) in the raffinate stream.

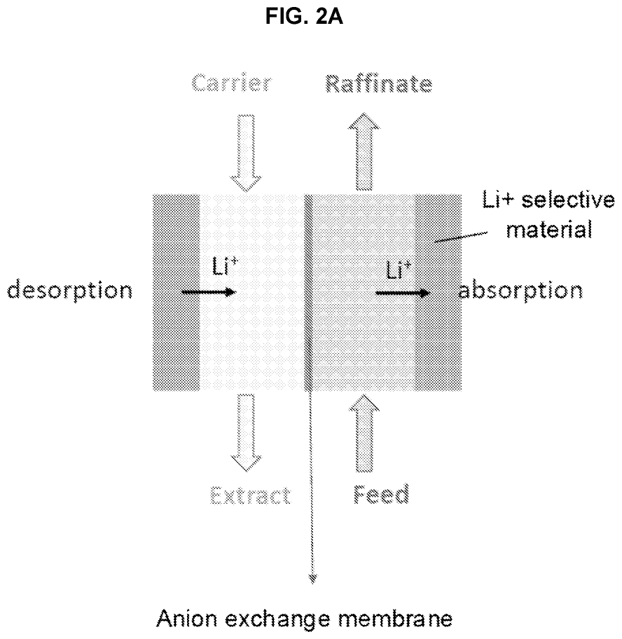

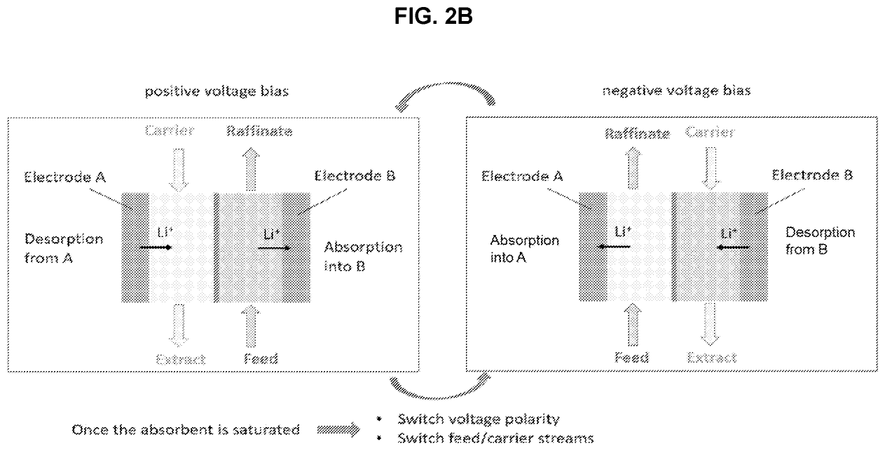

FIG. 2A shows a schematic illustration of an exemplary absorption/desorption DLE process that includes an electrochemical cell containing an anion exchange membrane separating two symmetric electrodes having the same lithium selective material. Carrier and feedstock streams flow through separate flow subchannels of the electrochemical cell and lithium is desorbed from and absorbed into the lithium selective material of the electrodes using an electric potential that generates an electric field across the cell. The selectivity of lithium is achieved using two designs: (1) the absorbents only absorb lithium ion; and (2) an anion exchange membrane is used that only allows anions to pass through (e.g., Cl⁻), while blocking the transport of cations. This way, the absorbent material can pick up lithium ions from a feed and hold them in the absorbents and then return lithium ions into a carrier when polarity and feeds are switched. The carrier fluid stream can be an aqueous medium with optional ions that picks up and carries away lithium ions which are desorbed from the lithium ion selective material. The carrier solution thus becomes lithium ion rich. A precipitating agent can be added to combine with extracted lithium to form a precipitate which can be easily removed. For example, precipitating agents such as sodium carbonate salt, sodium hydroxide, and the like can result in a precipitate such as lithium carbonate (Li₂CO₃) and lithium hydroxide (LiOH).

In this configuration, a negative bias electric field can be applied such that the lithium ions absorb into the lithium ion selective material. The solution that passes through the electrochemical cell reactor are then lithium ion-depleted (i.e., lower or no lithium ions depending on the exposure time, electrochemical cell reactor length, and strength of the applied electric potential field). The lithium-depleted solution can then be discharged back to the environment or otherwise directed. A carrier fluid can then be passed through the flow subchannel and the voltage bias is reversed to a positive bias such that lithium ions desorb from the lithium intercalation material to produce a lithium ion-rich solution.

FIG. 2B illustrates the continuous cycling between a positive voltage bias and a negative voltage bias to extract lithium from a lithium feed stream using the DLE electrochemical cell of FIG. 2A and a carrier stream of extraction solution. This example reactor has two identical absorbents as lithium ion selective materials on opposing sides of the anion exchange membrane (Electrodes A and B). When one electrode is saturated with Li⁺, the other electrode is depleted. Voltage is cycled from positive to negative bias in order to desorb and absorb lithium ions from each electrode, respectively. In each Li extraction cycle of this example, there are two steps: a positive voltage bias step and a negative voltage bias step (FIG. 2B).

When the lithium selective material (i.e., absorbent) becomes saturated with lithium ion at one electrode, the electric potential voltage polarity is switched between the two symmetric electrodes, and the flow of the feed and carrier streams are switched between the two adjacent flow subchannels separated by the anion exchange membrane within the flow channel of the electrochemical cell. This results in a continuous absorption of the lithium ion from the feed stream into the lithium selective material of the electrodes and desorption of the lithium ion from the lithium selective material of the electrodes into the carrier stream, thereby maximizing lithium extraction. The lithium-rich extract can be collected in a separate reservoir for analysis, subjected to further treatment, or otherwise removed from the extraction system, or the lithium-rich extract can be recycled and reintroduced into the carrier stream source of extraction solution. The lithium-depleted raffinate can be discarded or otherwise removed from the extraction system, or the lithium-depleted raffinate can be recycled and reintroduced into the feed stream source.

Before the Li extraction starts, Electrode A can be saturated with lithium ion and Electrode B can be depleted by a pre-treatment step. In the first positive voltage bias cycle (1+), a voltage is applied so that the Li⁺ is desorbed from Electrode A to enter the carrier stream. Meanwhile, on the other side of the flow cell, Li⁺ is absorbed into Electrode B from the feed. When Electrode B becomes saturated, the voltage polarity is switched, and the feed/carrier streams are also switched. Consequently, the first negative voltage bias cycle (1−) is entered. In the 1− voltage cycle, the lithium ion absorbed into Electrode B in the first positive voltage bias cycle (1+) from the feed is desorbed into the carrier. Meanwhile, Electrode A absorbs Li⁺ from the feed. The electrochemical cell reactor can operate by repeating this process a number of times. The extract can then be directly used for Li precipitation, or it can be directed back as the carrier to close the loop, in this case the Li⁺ concentration in the extract solution will increase with continuous cycling. This is an electrochemical cell, so the electric field across the cell is established when a voltage is applied on the two absorbents (which are part of the electrodes). Therefore, by switching the polarity of the electric field, the direction Li⁺ moves can be controlled. In the 1+ voltage cycle, the electric field drives Li⁺ to leave Electrode A and enter the carrier. Meanwhile, the anion exchange membrane does not allow Li⁺ to leave the carrier so Li⁺ concentration builds up in the carrier and other cations are blocked from entering the carrier.

Any suitable anion exchange membranes known in the art may be used in the electrochemical cells described herein. Anion exchange membranes contain positively charged functional groups on their backbone and free counter anions. A wide array of functional groups, including, but not limited to, ammonium, phosphonium, and sulphonium, can be utilized in the anion exchange membranes described herein.

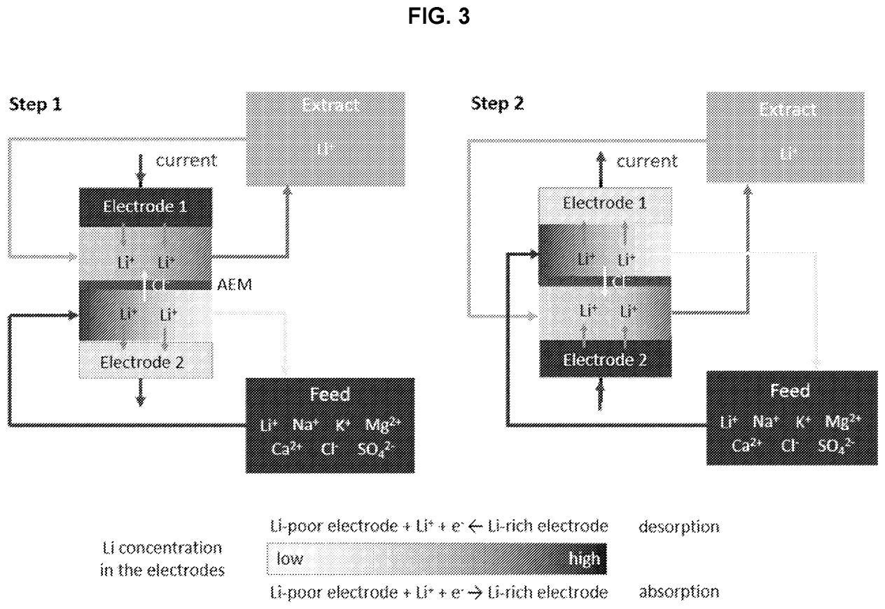

FIG. 3 shows another schematic illustration of an exemplary electrochemical DLE process that continuously switches the electric potential (current/voltage) between electrodes and the fluid flow of feed and carrier streams between flow subchannels of an electrochemical cell reactor. The flow subchannels are separated by an anion exchange membrane (AEM). In this non-limiting example, the feed stream contains a plurality of ions in addition to lithium. Similar to the configuration shown in FIG. 2B, the process results in a continuous cycling of absorption of the lithium ion from the feed stream into the lithium selective material of a lithium-poor electrode and desorption of the lithium ion from the lithium selective material of a lithium-rich electrode into the carrier stream. This design allows simultaneous Li absorption and desorption in one step, which enables two absorption steps in one electrochemical cycle. The constant voltage operation allows precise control of the absorption driving force, which enables the accurate match of the absorption rate with mass transfer rate, thereby eliminating mass transfer limitation, avoiding side reactions, and maximizing lithium selectivity and durability. In this non-limiting example, the lithium-depleted raffinates from each flow subchannel are recycled and reintroduced into the feed stream source, and the lithium-rich extracts from each flow subchannel are recycled and reintroduced into the carrier stream source.

The lithium ion concentrations in the two symmetric electrodes during absorption/desorption are depicted on the bottom of FIG. 3. Initially, Electrode 1 is at a relatively high Li concentration, while Electrode 2 is at a relatively low Li concentration (FIG. 3, left). Each absorption/desorption cycle involves two steps. In Step 1, the feed stream is pumped to flow by Electrode 2 through one flow subchannel, while a carrier stream is pumped to flow by Electrode 1 through a separate flow subchannel. Upon application of an electric current (or voltage), Li is desorbed from the Li-rich Electrode 1 and enters the carrier stream, while Li in the feed is absorbed by the Li-poor Electrode 2. Anionic species such as chloride (Cl⁻) are able to pass through the separating AEM from the feed into the carrier stream. Once a certain Li absorption capacity is reached in Electrode 2, Step 1 is completed and the system is ready for Step 2. In Step 2, the direction of the current (or the polarity of the voltage) is reversed, and the two streams of feed and carrier are switched between the two flow subchannels (FIG. 3, right). The Li from the feed is then absorbed by Electrode 1, and the Li in Electrode 2 is desorbed into the carrier stream, until a certain Li absorption capacity is reached in Electrode 1. After a full separation cycle, LiCl in the feedstock is transferred into the carrier stream as lithium extract.

The whole DLE process does not use any chemicals, does not produce any waste, and does not consume any water. By switching the polarity applied to the electrochemical cell back and forth, continuous extraction of Li from feedstock can be realized. The Li extraction capacity in each cycle depends on the specific size and the areal capacity of the electrodes. The speed of Li extraction depends on the specific flow rates of the feed and carrier streams, as well as the applied electric potential. The total energy consumption depends on the electrical energy used to drive the absorption/desorption, as well as the pumping energy.

To optimize the residence time within the electrochemical cells described herein for maximal lithium extraction through simultaneous absorption/desorption, the specific fluid flow rates and the particular sizes/dimensions of the electrodes, flow subchannels, and anion exchange membranes within the cells can be modulated accordingly.

The specific temperature and pressure parameters of the disclosed DLE systems and methods that are required for effective extraction of lithium from an aqueous lithium feedstock will depend on the specific environmental conditions, location where the lithium is to be extracted, and source of feedstock. For example, in some embodiments, the disclosed methods are performed, or the disclosed systems are operated, in situ at a natural site of an aqueous lithium feedstock. In other embodiments, the disclosed systems and methods are operated and performed at a non-natural site (i.e., the feedstock is collected from its natural site and the lithium is extracted elsewhere).

In some embodiments, the disclosed DLE systems and methods may comprise a constant temperature and/or pressure. In other embodiments, the disclosed DLE systems and methods may comprise a variable temperature and/or pressure. The disclosed systems and methods have the advantage of being able to be operated and performed at room temperature. As used herein, the terms “room temperature,” “RT,” and “ambient temperature” indicate a temperature of about 20-27° C., about 25° C.±10%, or ~25° C., at standard atmospheric pressure. By operating and performing the disclosed systems and methods at room temperature, it eliminates the need for process heat, eliminates any CO₂ emission associated with process heat, and eliminates the associated energy cost. Thus, the systems and methods disclosed herein may not require complicated equipment or high energy consumption as compared to conventional techniques.

### Additional Pre-Treatment, Electrodialysis, and Post-Treatment Operations

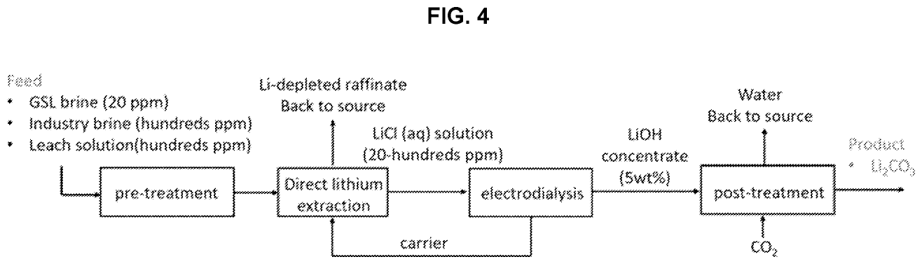

In some embodiments, depending on the specific source and type of lithium feedstock, pre-treatment steps may be performed (FIG. 4). These pre-treatment steps typically involve filtration steps to remove larger particulate matter and produce an aqueous lithium feedstock solution suitable for the DLE reaction units described herein. In addition, when a lithium-containing leaching solution is used as feedstock, such as from ore leaching, there may be various pre-treatment steps that are required for preparation of the feedstock solution before performing DLE (e.g., pH modulation). For example, an acidic leaching solution may first be neutralized with a pH modulating agent or buffer to generate an aqueous feedstock solution that is more suitable for the DLE systems and methods described herein.

In some embodiments, an electrodialysis flow cell can be used to further concentrate the lithium extract (e.g., LiCl solution) from the direct lithium extraction systems and methods described herein, and then further convert it to lithium hydroxide (LiOH) solution (FIG. 4). Any suitable electrodialysis flow cells and techniques known in the art can be used, including commercially available electrodialysis membranes and electrodes.

In certain non-limiting exemplary embodiments, the electrodialysis flow cell may comprise a nickel mesh as the cathode and a catalyst-loaded carbon cloth as the anode, and the body of the electrodialysis flow cell can be fabricated from acrylic plates. Two aluminum end plates can then be used to sandwich the components of the electrodialysis flow cell together.

In certain non-limiting exemplary embodiments, the electrodialysis flow cell may comprise a dilute LiOH catholyte, a LiCl solution from DLE, a salt solution (e.g., NaCl), and an Na₂SO₄ anolyte separated by a cation exchange membrane, an anion exchange membrane, and another cation exchange membrane. In this exemplary electrodialysis step, the overall reaction is:

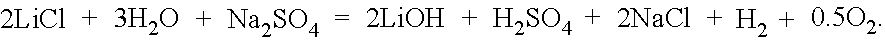

The four streams are respectively converted to a concentrated LiOH catholyte, a depleted LiCl solution, a concentrated salt (e.g., NaCl) solution, and a sulfuric acid anolyte. These streams are then respectively subjected to additional post-treatment, returned to the DLE system as the carrier stream, discharged back to the source, and collected as a high-value by-product. The produced sulfuric acid anolyte can also be recycled back and used in any pre-treatment steps for leaching, for example if lithium is being extracted from an ore leaching solution feedstock rather than a brine. H₂ and O₂ gases are produced respectively from the cathode and anode, which can be separated and collected as two additional high-value by-products. The amount of electric charge consumed in the electrodialysis step is proportional to the amount of Li⁺ being transferred into the catholyte. During electrodialysis, if conductivity is too low and energy consumption is too high due to dilute LiCl solution, forward osmosis can be performed to further concentrate the LiCl solution, and then electrodialysis can be used to convert the LiCl to LiOH.

In additional post-treatment processes following electrodialysis, carbon dioxide (CO₂) gas can be purged into the concentrated LiOH solution to generate solid lithium carbonate (Li₂CO₃) through precipitation (FIG. 4), according to the following reaction:

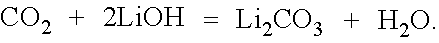

Thus, by using CO₂ as the carbon source to precipitate Li₂CO₃, the described systems and processes can be carbon negative. The purity of the produced Li₂CO₃ can then be analyzed using inductively coupled plasma-optical emission spectrometry (ICP-OES) and inductively coupled plasma-mass spectrometry (ICP-MS). X-ray diffraction (XRD) and scanning electron microscopy with energy dispersive X-ray spectroscopy (SEM-EDX) can also be employed to analyze the crystal structure, morphology, grain size, and size distribution of the produced Li₂CO₃ solid particles.

The systems and methods described herein can provide various advantages over conventional lithium extraction processes. Some of these potential advantages include, but are not limited to, the following: (1) low-to-zero water usage (e.g., less than 8% water loss); (2) very low chemical usage and waste production (e.g., less than 1.0 kg chemicals and less than 0.1 kg waste/kg Li₂CO₃), which greatly reduces operation costs; (3) lower environmental impact; (4) room temperature operation, which eliminates the need for process heat and the associated energy cost; (5) very low energy consumption (e.g., less than 1.0 kWh/kg Li) as ions can be separated from aqueous feedstock (e.g., brine), rather than separating water from brines; (6) ability to easily integrate into existing industry processes that handle Li-containing brines and co-product Li₂CO₃ with other products, such as potash, magnesium, caustic soda, and the like; (7) ability to handle a wide variety of lithium feedstocks, including various natural brines (e.g., lake brine, geothermal brine) and industry brines (e.g., produce water, leach solution); (8) more scalable than current commercial processes that rely on solar evaporation to concentrate Li brine before further treatments; (9) higher lithium separation and selectivity over other ions; (10) low-to-zero carbon emissions (e.g., less than 8.0 kg CO₂/kg Li₂CO₃); (11) higher throughputs (e.g., greater than 100 g Li₂CO₃/day); (12) ability to be powered by renewable electricity; and (13) improved sustainability and lower operation and maintenance costs due to the continuous and cyclic nature of the disclosed systems and methods (i.e., ability for “self-cleaning”).

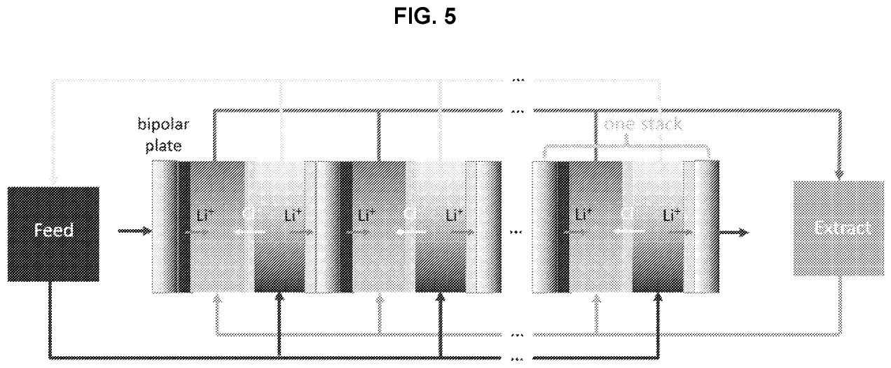

The electrochemical lithium extraction systems and methods described herein have the advantage of being easily implemented in larger-scale industrial lithium extraction operations. In industrial electrochemical processes, the size of the electrodes typically range from about 0.1 m² to about 10 m². In certain non-limiting exemplary embodiments described herein, symmetric electrodes of the disclosed electrochemical flow cells may comprise a size ranging from about 4 cm² to about 10 m². However, the particular size of the electrodes may be smaller or larger depending on the specific application and feedstock source. To further increase throughput, many electrochemical cells described herein can be stacked together in parallel, along with bipolar plates to help conduct electrical current from one cell stack to the next, as illustrated in FIG. 5. The number of parallel stackings can be as high as a few hundred flow cells, such as 500 cells or even greater. For example, in certain non-limiting exemplary embodiments, the disclosed systems and methods may comprise up to about 500 electrochemical cells stacked in parallel.

One embodiment described herein is a system for continuously and selectively extracting lithium from an aqueous lithium feedstock, the system comprising: an electrochemical cell comprising: a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet; a source of the aqueous lithium feedstock selectively fluidly coupled to either the first subchannel inlet or the second subchannel inlet through a first valve, the first valve being adapted to selectively adjust a fluid flow of the aqueous lithium feedstock from the source of the aqueous lithium feedstock to either the first subchannel inlet or the second subchannel inlet; a source of an extraction solution selectively fluidly coupled to either the first subchannel inlet or the second subchannel inlet through a second valve, the second valve being adapted to selectively adjust a fluid flow of the extraction solution from the source of the extraction solution to either the first subchannel inlet or the second subchannel inlet; a valve controller adapted to selectively configure the first and second valves such that when the source of the aqueous lithium feedstock is fluidly coupled to the first subchannel inlet, the source of the extraction solution is fluidly coupled to the second subchannel inlet, and when the source of the aqueous lithium feedstock is fluidly coupled to the second subchannel inlet, the source of the extraction solution is fluidly coupled to the first subchannel inlet; a fluid flow source operably coupled to the source of the aqueous lithium feedstock and the source of the extraction solution, the fluid flow source being configured to induce fluid flow of the aqueous lithium feedstock from the source of the aqueous lithium feedstock through either the first subchannel or the second subchannel and induce fluid flow of the extraction solution from the source of the extraction solution through either the first subchannel or the second subchannel; an electric potential source electrically coupled to the first and second electrodes; and an electric potential controller adapted to selectively adjust the electric potential applied to the first and second electrodes such that when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode.

In one aspect, the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof. In another aspect, the aqueous lithium feedstock comprises additional ions of sodium, potassium, magnesium, manganese, calcium, chloride, bromide, sulfate, or combinations thereof.

In another aspect, the extraction solution comprises an aqueous salt solution comprising potassium chloride, sodium chloride, or a combination thereof.

In another aspect, the lithium selective material comprises lithium iron phosphate, lithium manganese oxide, lithium titanium oxide, or combinations thereof.

In another aspect, each of the first and second electrodes comprises a size ranging from about 4 cm² to about 10 m².

In another aspect, the electric potential applied to the first and second electrodes ranges from about 100 mV to about 1500 mV. In one non-limiting exemplary embodiment, the electric potential applied to the first and second electrodes ranges from about 200 mV to about 1000 mV.

In another aspect, the fluid flow source is a pump.

In another aspect, the system comprises a plurality of electrochemical cells. In another aspect, the plurality of electrochemical cells comprises up to about 500 electrochemical cells stacked in parallel.

In another aspect, the system extracts lithium in the form of an aqueous lithium chloride solution. In another aspect, the system further comprises an electrodialysis flow cell. In another aspect, the electrodialysis flow cell is configured to convert aqueous lithium chloride solution into aqueous lithium hydroxide solution. In another aspect, the system further comprises a source of carbon dioxide gas to precipitate the aqueous lithium hydroxide solution to generate solid lithium carbonate.

In another aspect, the system is operated at room temperature. In another aspect, the system is carbon negative. In another aspect, the system has a selectivity for lithium of at least about 85% over other ions.

Another embodiment described herein is a method of continuously and selectively extracting lithium from an aqueous lithium feedstock, the method comprising: (a) providing an electrochemical cell comprising: a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet; (b) inducing a fluid flow of the aqueous lithium feedstock from a source of the aqueous lithium feedstock to either the first subchannel inlet or the second subchannel inlet, and simultaneously inducing a fluid flow of an extraction solution from a source of the extraction solution to either the first subchannel inlet or the second subchannel inlet, wherein the aqueous lithium feedstock and the extraction solution simultaneously flow to opposing first or second subchannel inlets; (c) applying an electric potential to the first and second electrodes such that the first electrode and the second electrode have opposing positive or negative electric potentials, wherein when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode; (d) switching the fluid flow of the aqueous lithium feedstock to the opposing first or second subchannel inlet, and simultaneously switching the fluid flow of the extraction solution to the opposing first or second subchannel inlet; and (e) switching the electric potential of the first and second electrodes to the opposing positive or negative electric potential.

In one aspect, the method further comprises: (f) repeating steps (b)-(e) one or more times.

In another aspect, the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof. In another aspect, the aqueous lithium feedstock comprises additional ions of sodium, potassium, magnesium, manganese, calcium, chloride, bromide, sulfate, or combinations thereof.

In another aspect, the extraction solution comprises an aqueous salt solution comprising potassium chloride, sodium chloride, or a combination thereof.

In another aspect, the lithium selective material comprises lithium iron phosphate, lithium manganese oxide, lithium titanium oxide, or combinations thereof.

In another aspect, the electric potential applied to the first and second electrodes ranges from about 100 mV to about 1500 mV. In one non-limiting exemplary embodiment, the electric potential applied to the first and second electrodes ranges from about 200 mV to about 1000 mV.

In another aspect, the fluid flow of the aqueous lithium feedstock and the extraction solution is induced using a fluid flow source comprising a pump.

In another aspect, the method extracts lithium in the form of an aqueous lithium chloride solution. In another aspect, the method further comprises adding the extracted lithium to an electrodialysis flow cell. In another aspect, the electrodialysis flow cell converts aqueous lithium chloride solution into aqueous lithium hydroxide solution. In another aspect, the method further comprises adding carbon dioxide gas to precipitate the aqueous lithium hydroxide solution and generate solid lithium carbonate.

In another aspect, the method is performed at room temperature. In another aspect, the method is carbon negative. In another aspect, the method has a selectivity for lithium of at least about 85% over other ions.

It will be apparent to one of ordinary skill in the relevant art that suitable modifications and adaptations to the compositions, systems, methods, processes, and applications described herein can be made without departing from the scope of any embodiments or aspects thereof. The systems and methods provided are exemplary and are not intended to limit the scope of any of the specified embodiments. All of the various embodiments, aspects, and options disclosed herein can be combined in any variations or iterations. The scope of the compositions, systems, methods, processes, and applications described herein include all actual or potential combinations of embodiments, aspects, options, steps, examples, and preferences herein described. The exemplary systems and methods described herein may omit any component, substitute any component disclosed herein, or include any component disclosed elsewhere herein. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:
Clause 1. A system for continuously and selectively extracting lithium from an aqueous lithium feedstock, the system comprising:
   an electrochemical cell comprising:
      a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and
      an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet;
   a source of the aqueous lithium feedstock selectively fluidly coupled to either the first subchannel inlet or the second subchannel inlet through a first valve, the first valve being adapted to selectively adjust a fluid flow of the aqueous lithium feedstock from the source of the aqueous lithium feedstock to either the first subchannel inlet or the second subchannel inlet;
   a source of an extraction solution selectively fluidly coupled to either the first subchannel inlet or the second subchannel inlet through a second valve, the second valve being adapted to selectively adjust a fluid flow of the extraction solution from the source of the extraction solution to either the first subchannel inlet or the second subchannel inlet;
   a valve controller adapted to selectively configure the first and second valves such that when the source of the aqueous lithium feedstock is fluidly coupled to the first subchannel inlet, the source of the extraction solution is fluidly coupled to the second subchannel inlet, and when the source of the aqueous lithium feedstock is fluidly coupled to the second subchannel inlet, the source of the extraction solution is fluidly coupled to the first subchannel inlet;
   a fluid flow source operably coupled to the source of the aqueous lithium feedstock and the source of the extraction solution, the fluid flow source being configured to induce fluid flow of the aqueous lithium feedstock from the source of the aqueous lithium feedstock through either the first subchannel or the second subchannel and induce fluid flow of the extraction solution from the source of the extraction solution through either the first subchannel or the second subchannel;
   an electric potential source electrically coupled to the first and second electrodes; and
   an electric potential controller adapted to selectively adjust the electric potential applied to the first and second electrodes such that when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode.
Clause 2. The system of clause 1, wherein the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof.
Clause 3. The system of clause 1 or 2, wherein the aqueous lithium feedstock comprises additional ions of sodium, potassium, magnesium, manganese, calcium, chloride, bromide, sulfate, or combinations thereof.
Clause 4. The system of any one of clauses 1-3, wherein the extraction solution comprises an aqueous salt solution comprising potassium chloride, sodium chloride, or a combination thereof.
Clause 5. The system of any one of clauses 1-4, wherein the lithium selective material comprises lithium iron phosphate, lithium manganese oxide, lithium titanium oxide, or combinations thereof.
Clause 6. The system of any one of clauses 1-5, wherein each of the first and second electrodes comprises a size ranging from about 4 cm² to about 10 m².
Clause 7. The system of any one of clauses 1-6, wherein the electric potential applied to the first and second electrodes ranges from about 100 mV to about 1500 mV.
Clause 8. The system of any one of clauses 1-7, wherein the fluid flow source is a pump.
Clause 9. The system of any one of clauses 1-8, wherein the system comprises a plurality of electrochemical cells.
Clause 10. The system of any one of clauses 1-9, wherein the plurality of electrochemical cells comprises up to about 500 electrochemical cells stacked in parallel.
Clause 11. The system of any one of clauses 1-10, wherein the system extracts lithium in the form of an aqueous lithium chloride solution.
Clause 12. The system of any one of clauses 1-11, further comprising an electrodialysis flow cell.
Clause 13. The system of any one of clauses 1-12, wherein the electrodialysis flow cell is configured to convert aqueous lithium chloride solution into aqueous lithium hydroxide solution.
Clause 14. The system of any one of clauses 1-13, further comprising a source of carbon dioxide gas to precipitate the aqueous lithium hydroxide solution to generate solid lithium carbonate.
Clause 15. The system of any one of clauses 1-14, wherein the system is operated at room temperature.
Clause 16. The system of any one of clauses 1-15, wherein the system is carbon negative.
Clause 17. The system of any one of clauses 1-16, wherein the system has a selectivity for lithium of at least about 85% over other ions.
Clause 18. A method of continuously and selectively extracting lithium from an aqueous lithium feedstock, the method comprising:
   (a) providing an electrochemical cell comprising:
      a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and
      an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet;
   (b) inducing a fluid flow of the aqueous lithium feedstock from a source of the aqueous lithium feedstock to either the first subchannel inlet or the second subchannel inlet, and simultaneously inducing a fluid flow of an extraction solution from a source of the extraction solution to either the first subchannel inlet or the second subchannel inlet, wherein the aqueous lithium feedstock and the extraction solution simultaneously flow to opposing first or second subchannel inlets;
   (c) applying an electric potential to the first and second electrodes such that the first electrode and the second electrode have opposing positive or negative electric potentials, wherein when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode;
   (d) switching the fluid flow of the aqueous lithium feedstock to the opposing first or second subchannel inlet, and simultaneously switching the fluid flow of the extraction solution to the opposing first or second subchannel inlet; and
   (e) switching the electric potential of the first and second electrodes to the opposing positive or negative electric potential.
Clause 19. The method of clause 18, further comprising:
   (f) repeating steps (b)-(e) one or more times.
Clause 20. The method of clause 18 or 19, wherein the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof.
Clause 21. The method of any one of clauses 18-20, wherein the aqueous lithium feedstock comprises additional ions of sodium, potassium, magnesium, manganese, calcium, chloride, bromide, sulfate, or combinations thereof.
Clause 22. The method of any one of clauses 18-21, wherein the extraction solution comprises an aqueous salt solution comprising potassium chloride, sodium chloride, or a combination thereof.
Clause 23. The method of any one of clauses 18-22, wherein the lithium selective material comprises lithium iron phosphate, lithium manganese oxide, lithium titanium oxide, or combinations thereof.
Clause 24. The method of any one of clauses 18-23, wherein the electric potential applied to the first and second electrodes ranges from about 100 mV to about 1500 mV.
Clause 25. The method of any one of clauses 18-24, wherein the fluid flow of the aqueous lithium feedstock and the extraction solution is induced using a pump.
Clause 26. The method of any one of clauses 18-25, wherein the method extracts lithium in the form of an aqueous lithium chloride solution.
Clause 27. The method of any one of clauses 18-26, further comprising adding the extracted lithium to an electrodialysis flow cell.
Clause 28. The method of any one of clauses 18-27, wherein the electrodialysis flow cell converts aqueous lithium chloride solution into aqueous lithium hydroxide solution.
Clause 29. The method of any one of clauses 18-28, further comprising adding carbon dioxide gas to precipitate the aqueous lithium hydroxide solution and generate solid lithium carbonate.
Clause 30. The method of any one of clauses 18-29, wherein the method is performed at room temperature.
Clause 31. The method of any one of clauses 18-30, wherein the method is carbon negative.
Clause 32. The method of any one of clauses 18-31, wherein the method has a selectivity for lithium of at least about 85% over other ions.

### EXAMPLES

### Direct Lithium Extraction

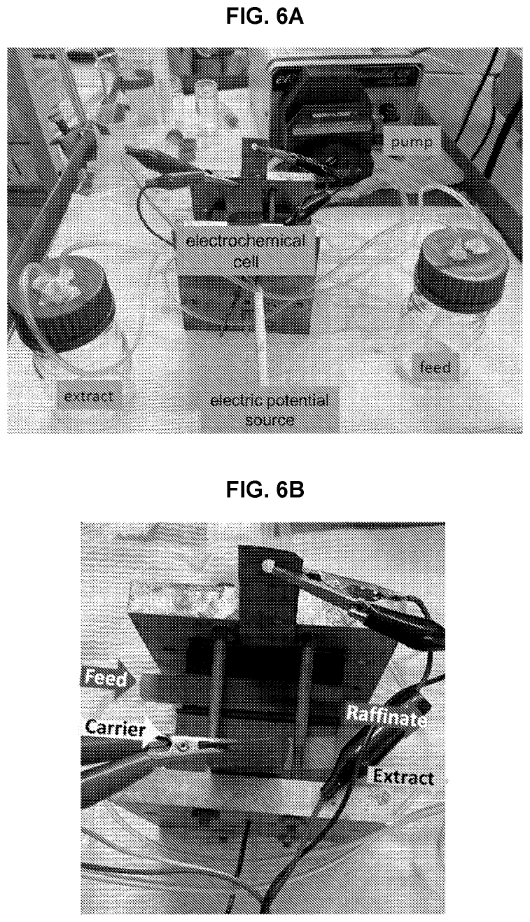

The continuous production of extracted lithium (e.g., LiCl solution) from an artificial brine feedstock through direct lithium extraction (DLE) was successfully demonstrated using a benchtop prototype shown in FIGS. 6A and 6B. The exemplary prototype system shown in FIG. 6A included a pump for inducing fluid flow, an electrochemical cell reactor for lithium ion absorption/desorption, an electric potential source, a lithium feedstock source (labeled “feed”), and a carrier stream source of extraction solution (labeled “extract”). FIG. 6B shows a zoomed-in photograph of the electrochemical cell reactor of FIG. 6A. Each of the symmetric electrodes of the reactor had a size of 4 cm² and a lithium selective material of commercially available lithium iron phosphate (LiFePO₄). The two electrodes were first charged to 20% and 80% state of charge before they were used in the electrochemical cell reactor. Tubes having a size of 1/16 inch were used for fluid flow and transport, and the fluid flow rate of the feed and carrier streams was 50 mL/min. The anion exchange membrane separating the two flow subchannels of the reactor was a 10 cm² Fumasep® FAS-30 anion exchange membrane. For each test, 1 full cycle (two steps) of lithium absorption/desorption was performed in the system.

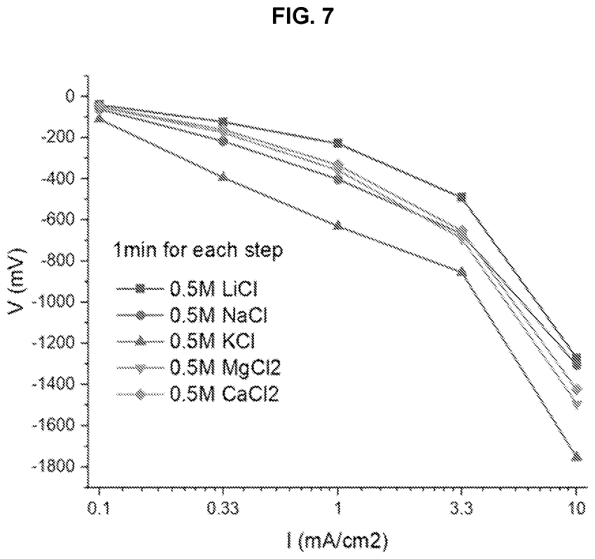

The selectivity of the exemplary DLE process was first evaluated by pumping a single ion stream as the feed and observing the required voltage to drive a given absorption current (FIG. 7). For a given absorption current, the required voltage was found to increase in the order of Li<Mg~Ca<Na<<K. These results suggested that the selectivity of the DLE system was in the order of Li>Mg~Ca>Na>>K.

Given that Mg had the closest selectivity to Li, and Na is typically the most abundant ion in brines, extraction experiments were conducted using Li/Na and Li/Mg binary cation mixtures as the feed. The extraction and selectivity results are provided in Table 1.

TABLE 1
Extraction and selectivity results after one
pass through the DLE electrochemical cell.

| | | | | Extract | | |
|---|---|---|---|---|---|---|
| | Feed | Feed co- | | co- | Extract | |
| | Li⁺ | cation | Applied | cation | Li⁺ | Selec- |
| | conc. | conc. | voltage | conc. | conc. | tivity |
| Feed | (mM) | (mM) | (mV) | (mM) | (mM) | (%) |
| Li/Na | 5 | 500 | 200 | 0.38 | 3.35 | 89.8 |
| mixture | | | 600 | 1.34 | 2.39 | 64.1 |
| | | | 1000 | 1.59 | 2.14 | 57.4 |
| Li/Mg | 12.5 | 250 | 200 | 0.15 | 2.11 | 87.6 |
| mixture | | | 600 | 0.18 | 3.09 | 89.6 |
| | | | 1000 | 0.13 | 2.97 | 92.0 |

Using 200 mV voltage as the driving electrical force, 89.8% of Li was able to be extracted from the Li/Na feed (i.e., 89.8% selectivity) and 87.6% of Li was able to be extracted from the Li/Mg feed (i.e., 87.6% selectivity). The separation factor, throughput, and energy consumption results of the exemplary DLE process are provided in Table 2.

TABLE 2
Separation factor, throughput, and energy consumption
results of the exemplary DLE process.

| | Applied | | | | | |
|---|---|---|---|---|---|---|
| | voltage | C_{Li}/C_{co-cation} | C_{Li}/C_{co-cation} | Separation | Throughput | Energy |
| Feed | (mV) | in the feed | in the extract | factor | (g Li₂CO₃/day) | (kWh/kg Li) |
| Li/Na | 200 | 0.01 | 8.9 | 890 | 0.017 | 0.85 |
| mixture | 600 | 0.01 | 1.78 | 178 | 0.209 | 1.2 |
| | 1000 | 0.01 | 1.35 | 135 | 0.579 | 6.76 |
| Li/Mg | 200 | 0.05 | 14.1 | 282 | 0.015 | 1.39 |
| mixture | 600 | 0.05 | 17.2 | 344 | 0.262 | 0.93 |
| | 1000 | 0.05 | 22.8 | 456 | 0.321 | 4.81 |

The relative concentration of Li was enriched by 890 times from 0.01 to 8.9 in the Li/Na mixture system at 200 mV applied voltage (separation factor=890), and enriched by 456 times from 0.05 to 22.8 in the Li/Mg mixture system at 1000 mV applied voltage (separation factor=456). The energy consumption was as low as 0.85 kWh/kg Li for the Li/Na mixture system at 200 mV applied voltage. The throughput was dependent on the applied voltage, and an equivalent Li₂CO₃ production of up to 0.5 g/day or higher was achieved.

The DLE process is further tested using three different types of feedstock: (1) pristine brine water having a Li content of ~20 ppm; (2) a pre-concentrated brine from an industry pond having a Li content of a few hundred ppm; and (3) a leaching solution from Li-containing ore (spodumene). A lithium-bearing feedstock solution from a lithium clay source is also evaluated.

Upon collection, these feedstocks undergo characterization through ICP-OES to determine their specific composition. The analysis of anions in the brine samples is conducted using selective ion electrodes and ion chromatography. Speciation studies are carried out on the solution chemistry to determine the relationship between concentration and solubility of various salts, identifying potential areas for optimization. The brine solutions are filtered to remove any crystallized salts for subsequent DLE through lithium absorption and desorption.

The specific system and process conditions, including applied voltage, capacity, and feed and carrier stream flow rates, are varied to examine the dependence of process performance on these parameters. The obtained LiCl solutions are analyzed by ICP-OES or ICP-MS to quantify the concentration of Li ion and other ions. Based on the data, the process performances, including selectivity, separation factor, production rate, throughput, and energy consumption, are calculated.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

1. A system for continuously and selectively extracting lithium from an aqueous lithium feedstock, the system comprising:
an electrochemical cell comprising:
a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and
an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet;
a source of the aqueous lithium feedstock selectively fluidly coupled to either the first subchannel inlet or the second subchannel inlet through a first valve, the first valve being adapted to selectively adjust a fluid flow of the aqueous lithium feedstock from the source of the aqueous lithium feedstock to either the first subchannel inlet or the second subchannel inlet;
a source of an extraction solution selectively fluidly coupled to either the first subchannel inlet or the second subchannel inlet through a second valve, the second valve being adapted to selectively adjust a fluid flow of the extraction solution from the source of the extraction solution to either the first subchannel inlet or the second subchannel inlet;
a valve controller adapted to selectively configure the first and second valves such that when the source of the aqueous lithium feedstock is fluidly coupled to the first subchannel inlet, the source of the extraction solution is fluidly coupled to the second subchannel inlet, and when the source of the aqueous lithium feedstock is fluidly coupled to the second subchannel inlet, the source of the extraction solution is fluidly coupled to the first subchannel inlet;
a fluid flow source operably coupled to the source of the aqueous lithium feedstock and the source of the extraction solution, the fluid flow source being configured to induce fluid flow of the aqueous lithium feedstock from the source of the aqueous lithium feedstock through either the first subchannel or the second subchannel and induce fluid flow of the extraction solution from the source of the extraction solution through either the first subchannel or the second subchannel;
an electric potential source electrically coupled to the first and second electrodes; and
an electric potential controller adapted to selectively adjust the electric potential applied to the first and second electrodes such that when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode.

2. The system of claim 1, wherein the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof.

3. The system of claim 1, wherein the aqueous lithium feedstock comprises additional ions of sodium, potassium, magnesium, manganese, calcium, chloride, bromide, sulfate, or combinations thereof.

4. The system of claim 1, wherein the extraction solution comprises an aqueous salt solution comprising potassium chloride, sodium chloride, or a combination thereof.

5. The system of claim 1, wherein the lithium selective material comprises lithium iron phosphate, lithium manganese oxide, lithium titanium oxide, or combinations thereof.

6. The system of claim 1, wherein each of the first and second electrodes comprises a size ranging from about 4 cm² to about 10 m².

7. The system of claim 1, wherein the electric potential applied to the first and second electrodes ranges from about 100 mV to about 1500 mV.

8. The system of claim 1, wherein the fluid flow source is a pump.

9. The system of claim 1, wherein the system comprises a plurality of electrochemical cells.

10. The system of claim 9, wherein the plurality of electrochemical cells comprises up to about 500 electrochemical cells stacked in parallel.

11. The system of claim 1, wherein the system extracts lithium in the form of an aqueous lithium chloride solution.

12. The system of claim 1, further comprising an electrodialysis flow cell.

13. The system of claim 12, wherein the electrodialysis flow cell is configured to convert aqueous lithium chloride solution into aqueous lithium hydroxide solution.

14. The system of claim 13, further comprising a source of carbon dioxide gas to precipitate the aqueous lithium hydroxide solution to generate solid lithium carbonate.

15. The system of claim 1, wherein the system is operated at room temperature.

16. The system of claim 1, wherein the system is carbon negative.

17. The system of claim 1, wherein the system has a selectivity for lithium of at least about 85% over other ions.

18. A method of continuously and selectively extracting lithium from an aqueous lithium feedstock, the method comprising:
(a) providing an electrochemical cell comprising:
a first electrode and a second electrode each comprising a lithium selective material, wherein the lithium selective material of the first electrode is the same as the lithium selective material of the second electrode, and wherein the first electrode and the second electrode are spaced apart to define a flow channel between the first electrode and the second electrode; and
an anion exchange membrane separating the flow channel into a first subchannel of the flow channel and a second subchannel of the flow channel, the first subchannel being in fluid communication with the first electrode and a first side of the anion exchange membrane and comprising a first subchannel inlet and outlet, and the second subchannel being in fluid communication with the second electrode and a second opposing side of the anion exchange membrane and comprising a second subchannel inlet and outlet;
(b) inducing a fluid flow of the aqueous lithium feedstock from a source of the aqueous lithium feedstock to either the first subchannel inlet or the second subchannel inlet, and simultaneously inducing a fluid flow of an extraction solution from a source of the extraction solution to either the first subchannel inlet or the second subchannel inlet, wherein the aqueous lithium feedstock and the extraction solution simultaneously flow to opposing first or second subchannel inlets;
(c) applying an electric potential to the first and second electrodes such that the first electrode and the second electrode have opposing positive or negative electric potentials, wherein when the extraction solution flows through the first subchannel and the aqueous lithium feedstock flows through the second subchannel, a positive electric potential is applied to the first electrode and a negative electric potential is applied to the second electrode, and when the aqueous lithium feedstock flows through the first subchannel and the extraction solution flows through the second subchannel, a positive electric potential is applied to the second electrode and a negative electric potential is applied to the first electrode;
(d) switching the fluid flow of the aqueous lithium feedstock to the opposing first or second subchannel inlet, and simultaneously switching the fluid flow of the extraction solution to the opposing first or second subchannel inlet; and
(e) switching the electric potential of the first and second electrodes to the opposing positive or negative electric potential.

19. The method of claim 18, further comprising:
(f) repeating steps (b)-(e) one or more times.

20. The method of claim 18, wherein the aqueous lithium feedstock comprises a brine, a lake brine, lake water, sea water, industrial effluent, industry brine, salt lake water, a geothermal brine, a desalinization plant brine, an oilfield brine, a leaching solution, or combinations thereof.

21. The method of claim 18, wherein the aqueous lithium feedstock comprises additional ions of sodium, potassium, magnesium, manganese, calcium, chloride, bromide, sulfate, or combinations thereof.

22. The method of claim 18, wherein the extraction solution comprises an aqueous salt solution comprising potassium chloride, sodium chloride, or a combination thereof.

23. The method of claim 18, wherein the lithium selective material comprises lithium iron phosphate, lithium manganese oxide, lithium titanium oxide, or combinations thereof.

24. The method of claim 18, wherein the electric potential applied to the first and second electrodes ranges from about 100 mV to about 1500 mV.

25. The method of claim 18, wherein the fluid flow of the aqueous lithium feedstock and the extraction solution is induced using a pump.

26. The method of claim 18, wherein the method extracts lithium in the form of an aqueous lithium chloride solution.

27. The method of claim 18, further comprising adding the extracted lithium to an electrodialysis flow cell.

28. The method of claim 27, wherein the electrodialysis flow cell converts aqueous lithium chloride solution into aqueous lithium hydroxide solution.

29. The method of claim 28, further comprising adding carbon dioxide gas to precipitate the aqueous lithium hydroxide solution and generate solid lithium carbonate.

30. The method of claim 18, wherein the method is performed at room temperature.

31. The method of claim 18, wherein the method is carbon negative.

32. The method of claim 18, wherein the method has a selectivity for lithium of at least about 85% over other ions.
